(19) United States
(12) Patent Application Publication
(10) Pub. No.: US 2026/0121958 A1
(43) Pub. Date: Apr. 30, 2026

(54) JITTER TOLERANCE MEASUREMENT APPARATUS AND JITTER TOLERANCE MEASUREMENT METHOD

(71) Applicant: ANRITSU CORPORATION, Kanagawa (JP)

(72) Inventors: Mitsutaka ITO, Kanagawa (JP); Tatsuya IWAI, Kanagawa (JP); Hironori YOSHIOKA, Kanagawa (JP)

(21) Appl. No.: 19/365,349

(22) Filed: Oct. 22, 2025

(30) Foreign Application Priority Data
Oct. 29, 2024 (JP) 2024-190112

(51) Int. Cl. H04L 43/087; H04L 1/20

(52) U.S. Cl. CPC H04L 43/087; H04L 1/205

(57) ABSTRACT

A jitter tolerance measurement apparatus includes an error measurement unit that measures an error measurement value of an output signal of a DUT that receives a pattern signal in synchronization with a jitter clock subjected to phase modulation by a jitter modulation signal, over a predetermined measurement time, a jitter tolerance measurement unit that changes jitter amplitude and jitter frequency of the jitter modulation signal to estimate, as a jitter tolerance of the DUT, a maximum jitter amplitude at which the error measurement value measured by the error measurement unit is equal to or less than a predetermined allowable value for each jitter frequency, a confidence level calculation unit that calculates a confidence level related to an allowable value of an error rate of the output signal of the DUT, and a display unit that displays result display screens showing the jitter tolerance and the confidence level.

### TECHNICAL FIELD

The present invention relates to a jitter tolerance measurement apparatus and a jitter tolerance measurement method that measure a jitter tolerance of a device under test.

### BACKGROUND ART

For example, a jitter tolerance test that tests whether or not a reception unit of a device under test (DUT) has a desired jitter tolerance is performed in a communication standard such as a universal serial bus (USB) (registered trademark) or a peripheral component interconnect express (PCIe) (registered trademark) (for example, refer to Patent Documents 1 and 2).

FIG. 6 shows a configuration of a jitter tolerance measurement apparatus 70 in the related art that performs the jitter tolerance test. The jitter tolerance measurement apparatus 70 is configured of a jitter generator 71 that outputs a jitter clock subjected to phase modulation with a jitter modulation signal having variable jitter amplitude and jitter frequency, a pattern signal generator 72 that outputs, to a DUT 75, a pattern signal in synchronization with the jitter clock output from the jitter generator 71, and an error measurement device 73 that measures an error of an output signal of the DUT 75 with respect to the pattern signal.

The jitter tolerance measurement apparatus 70 configured as described above changes the jitter amplitude of the jitter modulation signal to measure, as the jitter tolerance of the DUT 75, a maximum jitter amplitude at which the number of errors or an error rate measured by the error measurement device 73 is equal to or less than a predetermined allowable value.

A lower limit value of the jitter tolerance required for the DUT 75 is provided as a jitter mask as shown in FIG. 7.

A confidence level (CL) related to the error rate of the output signal in a case where the jitter tolerance is obtained is defined by the following Equation (1). The confidence level CL represents a probability that a true error rate of the output signal of the DUT 75 is smaller than a target bit error rate (BER) defined in advance.

$$CL = 1 - {e}^{- N \times {BER}_{S}} \times {\sum }_{k = 0}^{E} \frac{{( N \times {ER}_{S} )}^{k}}{k !} \qquad ( 1 )$$

In Equation (1),
N: bit rate [bit/s]×measurement time [s](number of bits to be measured),
BERₛ: target BER, and
E: target number of errors.

### RELATED ART DOCUMENT

### Patent Document

[Patent Document 1] JP-A-H08-050156
[Patent Document 2] Japanese Patent No. 4376064

### DISCLOSURE OF THE INVENTION

### Problem that the Invention is to Solve

However, the measurement apparatuses in the related art disclosed in Patent Documents 1 and 2 cannot automatically evaluate the confidence level CL of the output signal of the DUT 75 in a case where the jitter tolerance is obtained.

Therefore, in the related art, in a case where the jitter tolerance test is performed, there is a problem in that in order to obtain the confidence level CL of a test result, a user oneself is required to perform complicated work such as opening a website or the like based on the test result and performing calculation.

The present invention has been made in order to solve such a problem of the related art, and an object of the present invention is to provide a jitter tolerance measurement apparatus and a jitter tolerance measurement method capable of automatically calculating a confidence level of an output signal of a device under test in a case where a jitter tolerance is obtained to quickly and easily check a confidence degree of the jitter tolerance after a jitter tolerance test.

### Means for Solving the Problem

In order to solve the above problem, according to an aspect of the present invention, there is provided a jitter tolerance measurement apparatus including a jitter modulation signal output unit that outputs a jitter modulation signal having variable jitter amplitude and jitter frequency, a jitter clock output unit that receives the jitter modulation signal from the jitter modulation signal output unit and outputs a jitter clock subjected to phase modulation in accordance with the jitter amplitude and the jitter frequency, a pattern signal generation unit that outputs a pattern signal in synchronization with the jitter clock to a device under test, an error measurement unit that measures the number of errors and an error rate of an output signal of the device under test that receives the pattern signal, over a predetermined measurement time, a jitter tolerance measurement unit that changes the jitter amplitude and the jitter frequency of the jitter modulation signal output from the jitter modulation signal output unit to estimate, as a jitter tolerance of the device under test, a maximum jitter amplitude at which the number of errors or the error rate measured by the error measurement unit is equal to or less than a predetermined allowable value for each jitter frequency, a display unit that displays result display screens showing the jitter tolerance and a setting screen for performing setting related to a measurement condition for the jitter tolerance, in which the result display screens display the jitter tolerance and a confidence level, and the setting screen includes a measurement time input unit to which the measurement time of the output signal is input, and a target error rate input unit to which an allowable value of the error rate of the output signal is input, and a confidence level calculation unit that calculates the confidence level related to the allowable value of the error rate of the output signal, in which the confidence level calculation unit calculates the confidence level based on a data rate of the output signal, the number of errors of the output signal in a case where the jitter tolerance is obtained by the jitter tolerance measurement unit, and the measurement time and the allowable value of the error rate that are input to the setting screen.

With this configuration, in the jitter tolerance measurement apparatus according to the aspect of the present invention, the confidence level of the output signal of the device under test in a case where the jitter tolerance is obtained is automatically calculated, and the jitter tolerance and the measurement result of the confidence level are displayed on the result display screen. Accordingly, in the jitter tolerance measurement apparatus according to the aspect of the present invention, the user can quickly and easily check the confidence degree of the jitter tolerance after the jitter tolerance test.

Further, in the jitter tolerance measurement apparatus according to an aspect of the present invention, the confidence level calculation unit may be configured to calculate the confidence level by substituting a product of the data rate and the measurement time into N of Equation (2), substituting the allowable value of the error rate into ERₛ of Equation (2), and substituting the number of errors into E of Equation (2).

$$CL = 1 - {e}^{- N \times {ER}_{S}} \times {\sum }_{k = 0}^{E} \frac{{( N \times {ER}_{S} )}^{k}}{k !} \qquad ( 2 )$$

Further, the jitter tolerance measurement apparatus according to an aspect of the present invention may be configured to further include a pass/fail determination unit that determines a pass or fail of the jitter tolerance with a jitter mask set in advance as a reference, in which the result display screens display the jitter tolerance, a determination result of the pass/fail determination unit, and the confidence level for each jitter frequency.

With this configuration, in the jitter tolerance measurement apparatus according to the aspect of the present invention, the determination result of the pass/fail determination unit and the confidence level are displayed on the result display screen for each jitter frequency. Accordingly, in the jitter tolerance measurement apparatus according to the aspect of the present invention, the user easily verifies the pass or fail determination by the pass/fail determination unit using the confidence level.

Further, the jitter tolerance measurement apparatus according to an aspect of the present invention may be configured to further include a result output unit that outputs the jitter tolerance, the determination result of the pass/fail determination unit, and the confidence level for each jitter frequency, which are displayed on the result display screens, in a predetermined file format.

With this configuration, in the jitter tolerance measurement apparatus according to the aspect of the present invention, the jitter tolerance, the determination result of the pass/fail determination unit, and the confidence level for each jitter frequency, which are displayed on the result display screen, are output in the predetermined file format. Accordingly, in the jitter tolerance measurement apparatus according to the aspect of the present invention, the user easily verifies the measurement result of the jitter tolerance test using the confidence level even at a later date after the jitter tolerance test.

Further, according to an aspect of the present invention, there is provided a jitter tolerance measurement method using a jitter tolerance measurement apparatus including a jitter modulation signal output unit that outputs a jitter modulation signal having variable jitter amplitude and jitter frequency, a jitter clock output unit that receives the jitter modulation signal from the jitter modulation signal output unit and outputs a jitter clock subjected to phase modulation in accordance with the jitter amplitude and the jitter frequency, a pattern signal generation unit that outputs a pattern signal in synchronization with the jitter clock to a device under test, an error measurement unit that measures the number of errors and an error rate of an output signal of the device under test, which receives the pattern signal, over a predetermined measurement time, a jitter tolerance measurement unit that changes the jitter amplitude and the jitter frequency of the jitter modulation signal output from the jitter modulation signal output unit to estimate, as a jitter tolerance of the device under test, a maximum jitter amplitude at which the number of errors or the error rate measured by the error measurement unit is equal to or less than a predetermined allowable value for each jitter frequency, and a display unit that displays result display screens showing the jitter tolerance and a setting screen, the jitter tolerance measurement method including: a setting screen display step of displaying, on the display unit, the setting screen for being used to perform setting related to a measurement condition for the jitter tolerance; an input step of inputting the measurement time of the output signal and an allowable value of the error rate of the output signal to the setting screen; a confidence level calculation step of calculating a confidence level related to the allowable value of the error rate based on a data rate of the output signal, the number of errors of the output signal in a case where the jitter tolerance is obtained by the jitter tolerance measurement unit, and the measurement time and the allowable value of the error rate that are input to the setting screen; and a result display screen display step of displaying, on the display unit, the result display screens showing the jitter tolerance and the confidence level, in which the setting screen includes a measurement time input unit to which the measurement time of the output signal is input, and a target error rate input unit to which the allowable value of the error rate of the output signal is input.

In the jitter tolerance measurement method according to an aspect of the present invention, in the confidence level calculation step, the confidence level may be configured to be calculated by substituting a product of the data rate and the measurement time into N of Equation (2), substituting the allowable value of the error rate into ERₛ of Equation (2), and substituting the number of errors into E of Equation (2).

$$CL = 1 - {e}^{- N \times {ER}_{S}} \times {\sum }_{k = 0}^{E} \frac{{( N \times {ER}_{S} )}^{k}}{k !} \qquad ( 2 )$$

Further, in the jitter tolerance measurement method according to an aspect of the present invention, pass/fail determination of determining a pass or fail of the jitter tolerance may be configured to be performed with a jitter mask set in advance as a reference, and the result display screens may be configured to display the jitter tolerance, a determination result of the pass/fail determination, and the confidence level for each jitter frequency.

Further, in the jitter tolerance measurement method according to an aspect of the present invention, a result output of outputting the jitter tolerance, the determination result of the pass/fail determination, and the confidence level for each jitter frequency, which are displayed on the result display screens, in a predetermined file format may be configured to be performed.

### Advantage of the Invention

The present invention provides the jitter tolerance measurement apparatus and the jitter tolerance measurement method capable of automatically calculating the confidence level of the output signal of the device under test in a case where the jitter tolerance is obtained to quickly and easily check the confidence degree of the jitter tolerance after the jitter tolerance test.

### BRIEF DESCRIPTION OF THE DRAWINGS

FIG. 1 is a block diagram showing a configuration of a jitter tolerance measurement apparatus according to an embodiment of the present invention.

FIG. 2 is an example of a setting screen of the jitter tolerance measurement apparatus according to the embodiment of the present invention.

FIG. 3 is an example of a result display screen of the jitter tolerance measurement apparatus according to the embodiment of the present invention.

FIG. 4 is an example of a detailed result display screen of the jitter tolerance measurement apparatus according to the embodiment of the present invention.

FIG. 5 is a flowchart showing processing of a jitter tolerance measurement method using the jitter tolerance measurement apparatus according to the embodiment of the present invention.

FIG. 6 is a block diagram showing a configuration of a jitter tolerance measurement apparatus in the related art.

FIG. 7 is a graph for describing an example of a jitter mask.

### BEST MODE FOR CARRYING OUT THE INVENTION

Hereinafter, embodiments of a jitter tolerance measurement apparatus and a jitter tolerance measurement method according to the present invention will be described with reference to drawings.

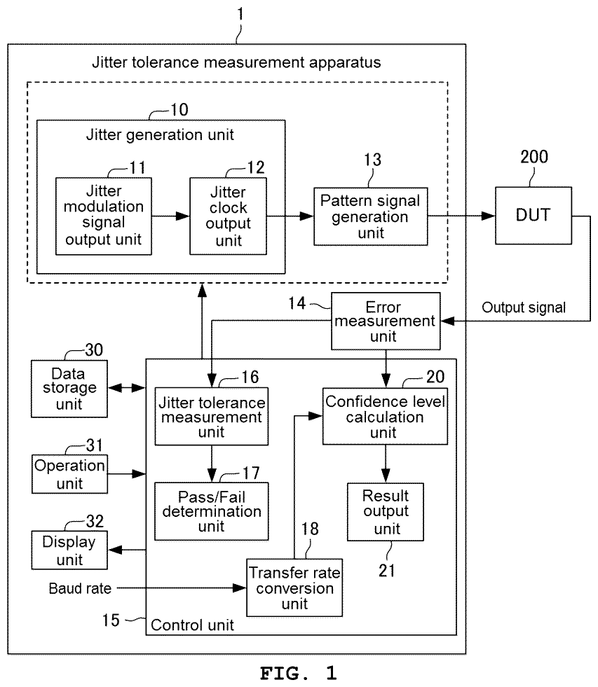

As shown in FIG. 1, a jitter tolerance measurement apparatus 1 according to an embodiment of the present invention performs a jitter tolerance test that measures a jitter tolerance of a DUT 200, and includes a jitter generation unit 10, a pattern signal generation unit 13, an error measurement unit 14, a control unit 15, a data storage unit 30, an operation unit 31, and a display unit 32.

Examples of a standard to which the DUT 200 corresponds include PCIe Gen1 to Gen6, universal serial bus (USB) (registered trademark) 3.0 to 4, common electrical interface (CEI), IEEE 802.3, InfiniBand HDR, and Fibre Channel.

The jitter generation unit 10 has a jitter modulation signal output unit 11 and a jitter clock output unit 12.

The jitter modulation signal output unit 11 outputs a jitter modulation signal having variable jitter amplitude and jitter frequency. The jitter modulation signal is, for example, a periodic jitter such as a sinusoidal jitter.

The jitter clock output unit 12 receives the jitter modulation signal from the jitter modulation signal output unit 11 and outputs a jitter clock subjected to phase modulation in accordance with the jitter amplitude and the jitter frequency of the jitter modulation signal.

The data storage unit 30 is configured with a memory, such as a random access memory (RAM). The data storage unit 30 stores, for example, bit sequence data (data of bit sequence consisting of 0 or 1) of a non-return-to-zero (NRZ) type signal (hereinafter, also simply referred to as “NRZ signal”) or symbol sequence data (data of symbol sequence consisting of 0, 1, 2, or 3) of a pulse amplitude modulation 4 (PAM4) type signal (hereinafter, also simply referred to as “PAM4 signal”), as signal data of a known pattern input to the DUT 200 from the pattern signal generation unit 13 described below.

Further, the data storage unit 30 may store the bit sequence data of a most significant bit (MSB) and a least significant bit (LSB) of the PAM4 signal input to the DUT 200. The symbol sequence data of the PAM4 signal, the bit sequence data of the MSB and the LSB, and the bit sequence data of the NRZ signal, which are stored in the data storage unit 30, also serve as reference data for being compared with an output signal of the DUT 200 by the error measurement unit 14, which will be described below.

The pattern signal generation unit 13 generates a pattern signal, which consists of the data of the known pattern input from the data storage unit 30, in synchronization with the jitter clock from the jitter clock output unit 12.

The pattern signal generation unit 13 outputs, as a test signal, the generated pattern signal to the DUT 200. In this case, the DUT 200 folds back the pattern signal output from the pattern signal generation unit 13, and uses the pattern signal as the output signal to the error measurement unit 14.

The error measurement unit 14 measures the number of errors and an error rate of the output signal of the DUT 200, which receives the pattern signal from the pattern signal generation unit 13, for each combination of the jitter amplitude and the jitter frequency of the jitter modulation signal over a predetermined measurement time.

The error measurement unit 14 sequentially compares the bit sequence data or the symbol sequence data, which is included in the output signal of the DUT 200, with the reference data, which is stored in the data storage unit 30, to calculate the error rate of the output signal of the DUT 200.

The jitter tolerance of the error measurement unit 14 itself is sufficiently higher than a measurement range of the jitter tolerance of the DUT 200.

The error measurement unit 14 counts the number of errors in the output signal of the DUT 200 over the measurement time set by a setting screen 40 described below. Further, the error measurement unit 14 calculates, as the error rate of the output signal of the DUT 200, a value obtained by dividing the counted number of errors by the number of pieces of measurement data of the output signal over the measurement time.

The control unit 15 is configured of a control device such as a computer including, for example, a central processing unit (CPU), a graphics processing unit (GPU), a field programmable gate array (FPGA), a read only memory (ROM), the RAM, and a hard disk drive (HDD).

The control unit 15 integrally controls the jitter generation unit 10, the pattern signal generation unit 13, the error measurement unit 14, the data storage unit 30, the operation unit 31, and the display unit 32. Further, for example, the control unit 15 causes the CPU or the GPU to execute a predetermined program to configure a jitter tolerance measurement unit 16, a pass/fail determination unit 17, a transfer rate conversion unit 18, a confidence level calculation unit 20, and a result output unit 21 in software.

The operation unit 31 is configured to receive an operation input from a user, and is configured of a user interface such as an operation knob, various keys, switches, and buttons, or soft keys on a display screen of the display unit 32, which is provided in the jitter tolerance measurement apparatus 1 shown in FIG. 1. Further, the operation unit 31 performs various settings related to the jitter tolerance measurement of the jitter tolerance measurement apparatus 1, and setting of various measurement conditions on the setting screen 40 described below.

The display unit 32 is configured of a display device, such as a liquid crystal display (LCD) or a cathode ray tube (CRT), and the like provided in the jitter tolerance measurement apparatus 1 shown in FIG. 1, and displays the setting screen 40, a result display screen 50, a detailed result display screen 60, and the like based on a display control signal from the control unit 15. The display unit 32 may have an operation function of the operation unit 31, such as the soft key on the display screen of the display unit 32.

The jitter tolerance measurement unit 16 changes the jitter amplitude and the jitter frequency of the jitter modulation signal, which is output by the jitter modulation signal output unit 11, to estimate, as the jitter tolerance of the DUT 200, a maximum jitter amplitude at which the number of errors or the error rate (hereinafter, also referred to as “error measurement value”) measured by the error measurement unit 14 is equal to or less than a predetermined allowable value Th for each jitter frequency.

For example, the jitter tolerance measurement unit 16 gradually increases the jitter amplitude from a predetermined lower limit value LL until the error measurement value exceeds the allowable value Th, and in a case where the error measurement value exceeds the allowable value Th while the jitter amplitude reaches a predetermined upper limit value UL, the maximum jitter amplitude before the error measurement value exceeds the allowable value Th is set as the jitter tolerance. In a case where the error measurement value does not exceed the allowable value Th even though the jitter amplitude is equal to or larger than the upper limit value UL, the jitter tolerance measurement unit 16 sets the upper limit value UL as the jitter tolerance. In a case where the error measurement value already exceeds the allowable value Th at the lower limit value LL of the jitter amplitude, the jitter tolerance measurement unit 16 sets the lower limit value LL as the jitter tolerance. The pass/fail determination unit 17 determines a pass or fail of the jitter tolerance, which is estimated by the jitter tolerance measurement unit 16, with a jitter mask set in advance as a reference.

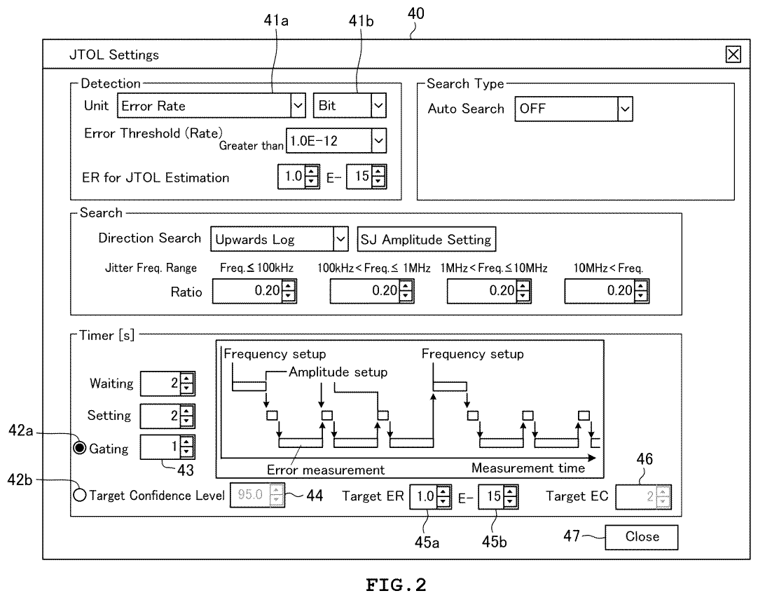

As shown in FIG. 2, the display unit 32 displays the setting screen 40 for performing setting related to the measurement conditions for the jitter tolerance of the output signal of the DUT 200.

The setting screen 40 includes “Unit” pull-down menus 41a and 41b, a “Gating” radio button 42a, a “Target Confidence Level” radio button 42b, a “Gating” spin box 43, a “Target Confidence Level” spin box 44, “Target ER” spin boxes 45a and 45b, a “Target EC” spin box 46, and a “Close” soft key 47.

In the “Unit” pull-down menu 41a, selection can be made whether the error measurement unit 14 measures the number of errors or the error rate of the output signal of the DUT 200. In the “Unit” pull-down menu 41b, for example, a measurement unit of the number of errors or the error rate, which is set in the “Unit” pull-down menu 41a, can be selected from among Bit, PAM4 Symbol, Flit, or Codeword.

In the “Gating” radio button 42a and the “Target Confidence Level” radio button 42b, selection can be made whether to set the measurement time in the “Gating” spin box 43 or to set a target confidence level CLs, which is an allowable value of the confidence level, in the “Target Confidence Level” spin box 44.

In a case where the “Gating” radio button 42a is selected, the measurement time can be input to the “Gating” spin box 43 in units of 1 second in a range of 1 second to 86,400 seconds, for example. That is, the “Gating” spin box 43 configures a measurement time input unit to which the measurement time of the output signal of the DUT 200 is input.

Further, in a case where the “Target Confidence Level” radio button 42b is selected, the “Gating” spin box 43 is in a state in which a value cannot be input, and the measurement time calculated by a unit (not illustrated) is displayed in units of 1 second in a range of 1 second to 172,800 seconds, for example.

In a case where the “Target Confidence Level” radio button 42b is selected, the target confidence level CLs can be input to the “Target Confidence Level” spin box 44 in units of 0.1% in a range of 0.0% to 99.9%, for example.

Further, in a case where the “Gating” radio button 42a is selected, the “Target Confidence Level” spin box 44 is in a state in which a value cannot be input.

The “Target ER” spin boxes 45a and 45b configure a target error rate input unit to which a target error rate ERₛ of the output signal of the DUT 200 is input. The target error rate ERₛ is an allowable value of the error rate of the output signal of the DUT 200 in the error measurement by the error measurement unit 14.

The target error rate ERₛ is input to the spin boxes 45a and 45b in an exponential notation, and a mantissa part is input to the spin box 45a and an exponent part is input to the spin box 45b. For example, a value in a range of 1E-15 to 9E-3 can be input to the spin boxes 45a and 45b.

In a case where the “Target Confidence Level” radio button 42b is selected, a target number of errors E during the measurement time of the output signal of the DUT 200 can be input to the “Target EC” spin box 46. For example, a value in a range of 0 to 10 can be input to the spin box 46. The unit of the target number of errors E input to the spin box 46 is changed according to the measurement unit selected in the “Unit” pull-down menu 41b.

Further, in a case where the “Gating” radio button 42a is selected, the “Target EC” spin box 46 is in a state in which a value cannot be input.

In a case where the user presses the “Close” soft key 47, the control unit 15 sets the measurement time currently displayed in the “Gating” spin box 43 to the error measurement unit 14, and ends the display of the setting screen 40.

The transfer rate conversion unit 18 converts a known baud rate of the output signal of the DUT 200 into a transfer rate (data rate) in accordance with the measurement unit of the output signal of the DUT 200. The baud rate of the output signal of the DUT 200 may be set on a setting screen (not illustrated).

The data rate is a parameter indicating the number of measurement units included in the output signal of the DUT 200 per second. The measurement unit is, for example, any one of Bit, PAM4 Symbol, Flit, or Codeword.

The target error rate ERₛ is, for example, any one of BER, Symbol Error Rate (SER), Uncorrectable Codeword Rate, or Flit Error Rate, and is an upper limit value that can be allowed as the error rate of the output signal.

The “Bit” is a measurement unit in a case where BER of the output signal of the DUT 200 is measured. In a case where the measurement unit is “Bit” and the output signal of the DUT 200 is the NRZ signal, the transfer rate conversion unit 18 outputs, as the data rate, the baud rate of the output signal of the DUT 200 as it is. In a case where the measurement unit is “Bit” and the output signal of the DUT 200 is the PAM4 signal, the transfer rate conversion unit 18 outputs, as the data rate, a rate obtained by doubling the baud rate of the output signal of the DUT 200.

The “PAM4 Symbol” is a measurement unit in a case where SER of the output signal of the DUT 200 is measured. In a case where the measurement unit is “PAM4 Symbol” and the output signal of the DUT 200 is the PAM4 signal, the transfer rate conversion unit 18 outputs, as the data rate, the baud rate of the output signal of the DUT 200 as it is.

The “Flit” is a measurement unit in a case where Flit Error Rate of the output signal of the DUT 200 is measured. In a case where the measurement unit is “Flit”, the transfer rate conversion unit 18 outputs, as the data rate, a rate obtained by doubling the baud rate of the output signal of the DUT 200 and dividing the doubled baud rate by a Flit length. The Flit length is 2,048 bits.

The “Codeword” is a measurement unit in a case where Uncorrectable Codeword Rate of the output signal of the DUT 200 is measured. In a case where the measurement unit is “Codeword”, the transfer rate conversion unit 18 outputs, as the data rate, a rate obtained by doubling the baud rate of the output signal of the DUT 200 and dividing the doubled baud rate by a Codeword (CW) length. In a case of Reed-Solomon forward error correction (RS-FEC) (544, 514) defined in IEEE 802.3, the CW length is 5,440 bits.

The confidence level calculation unit 20 calculates the confidence level related to the target error rate ERₛ, using the number of errors measured by the error measurement unit 14 in a case where the jitter tolerance measurement unit 16 obtains the jitter tolerance. The confidence level represents a probability that a true error rate of the output signal of the DUT 200 is smaller than the target error rate ERₛ.

Specifically, the confidence level calculation unit 20 calculates a confidence level CL by substituting a product of the data rate [data/s] output from the transfer rate conversion unit 18 and the measurement time [s] input to the “Gating” spin box 43 of the setting screen 40 into N of the following Equation (2), substituting the target error rate ERₛ input to the “Target ER” spin boxes 45a and 45b of the setting screen 40 into ERₛ of the following Equation (2), and substituting the number of errors measured by the error measurement unit 14 into E of the following Equation (2).

$$CL = 1 - {e}^{- N \times {ER}_{S}} \times {\sum }_{k = 0}^{E} \frac{{( N \times {ER}_{S} )}^{k}}{k !} \qquad ( 2 )$$

The N is a parameter indicating the number of measurement units included in the output signal of the DUT 200 over the measurement time, that is, the number of pieces of measurement data. The measurement unit can be set in the “Unit” pull-down menu 41b on the setting screen 40.

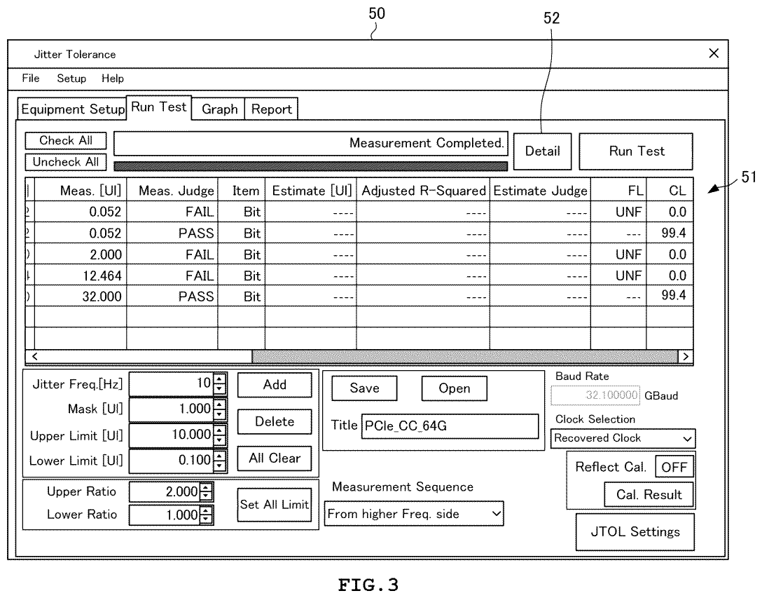

FIG. 3 shows the result display screen 50 displayed by the display unit 32. The result display screen 50 includes a measurement result table 51 and a “Detail” soft key 52.

A “Meas. [UI]” column in the measurement result table 51 shows the jitter tolerance, which is estimated by the jitter tolerance measurement unit 16, for each jitter frequency.

A “Meas. Judge” column in the measurement result table 51 shows a determination result by the pass/fail determination unit 17 for each jitter frequency. “PASS” indicates that the jitter tolerance, which is estimated by the jitter tolerance measurement unit 16, is equal to or larger than the jitter mask set in advance. “FAIL” indicates that the jitter tolerance, which is estimated by the jitter tolerance measurement unit 16, is less than the jitter mask set in advance.

A “CL” column in the measurement result table 51 shows the confidence level CL [%], which is calculated by the confidence level calculation unit 20, for each jitter frequency.

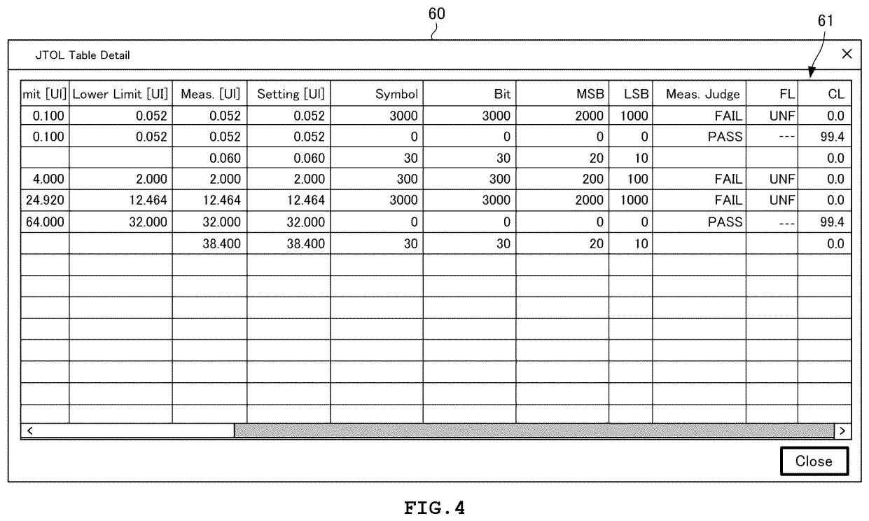

In a case where the user presses the “Detail” soft key 52, the control unit 15 displays the detailed result display screen 60 as shown in FIG. 4 on the display unit 32. In a detailed measurement result table 61 of the detailed result display screen 60, the jitter tolerance estimated by the jitter tolerance measurement unit 16 and the confidence level CL calculated by the confidence level calculation unit 20 are also shown for each jitter frequency.

In the example shown in FIGS. 3 and 4, all values of the confidence level CL in the “CL” column are 0.0% in a case where the determination result of the pass/fail determination unit 17 is “FAIL”. However, the confidence level CL may have a value larger than 0.0% depending on the allowable value Th of the number of errors or the error rate in the jitter tolerance measurement unit 16 and a value of the jitter mask.

The result output unit 21 outputs various measurement results including the jitter tolerance, the determination result, and the confidence level CL, which are displayed in the measurement result table 51 or the detailed measurement result table 61, in a predetermined file format. The predetermined file format is, for example, hypertext markup language (HTML) or comma separated values (CSV).

A file output from the result output unit 21 may be stored in the data storage unit 30 or may be stored in an external storage device or a computer-readable recording medium.

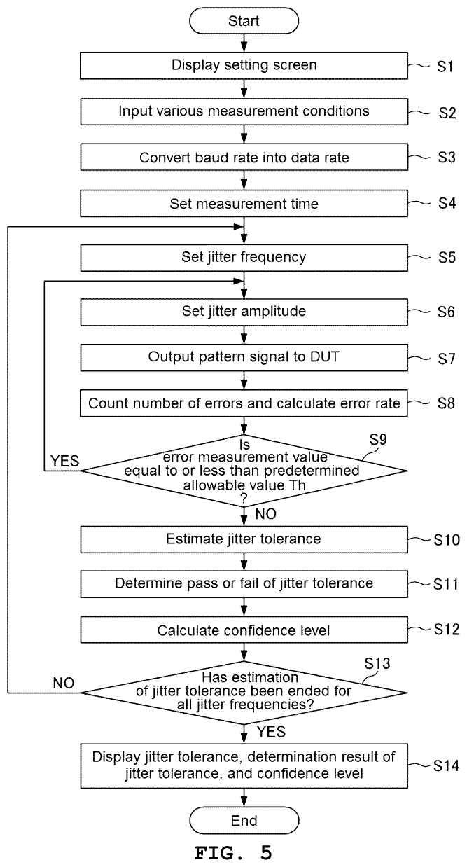

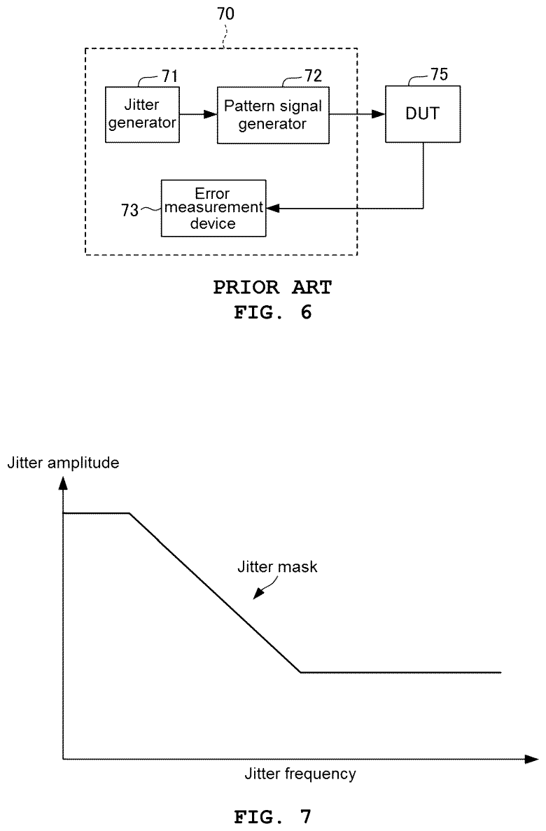

Hereinafter, an example of processing of the jitter tolerance measurement method using the jitter tolerance measurement apparatus 1 according to the present embodiment will be described with reference to a flowchart of FIG. 5. A description that overlaps with the description of the configuration of the jitter tolerance measurement apparatus 1 described above is omitted as appropriate.

First, the control unit 15 displays, on the display unit 32, the setting screen 40 for performing the setting related to the measurement conditions for the jitter tolerance of the output signal of the DUT 200 (setting screen display step S1).

Next, the user inputs, to the setting screen 40, the measurement conditions such as the measurement time of the output signal of the DUT 200, the measurement unit of the number of errors or the error rate of the output signal, and the target error rate ERₛ of the output signal, via the operation unit 31 (input step S2).

Next, the transfer rate conversion unit 18 converts the baud rate of the output signal of the DUT 200 into the transfer rate (data rate) in accordance with the measurement unit input to the setting screen 40 in the input step S2 (step S3).

Next, with the press of the “Close” soft key 47 on the setting screen 40 by the user, the control unit 15 sets the measurement time, which is currently displayed in the “Gating” spin box 43 on the setting screen 40, to the error measurement unit 14 (step S4).

Next, the jitter tolerance measurement unit 16 sets a predetermined jitter frequency in the jitter modulation signal output unit 11 (step S5).

Next, the jitter tolerance measurement unit 16 sets a predetermined jitter amplitude in the jitter modulation signal output unit 11 (step S6).

Next, the pattern signal generation unit 13 outputs, to the DUT 200, the pattern signal subjected to phase modulation in accordance with the jitter frequency and the jitter amplitude set in steps S5 and S6 (step S7).

Next, the error measurement unit 14 counts the number of errors in the output signal of the DUT 200 and calculates the error rate of the output signal of the DUT 200, over the measurement time set by the control unit 15 in step S4 (step S8).

Next, the jitter tolerance measurement unit 16 determines whether or not the error measurement value obtained in step S8 is equal to or less than the predetermined allowable value Th (step S9).

In a case where the error measurement value obtained in step S8 is equal to or less than the predetermined allowable value Th (YES in step S9), the jitter tolerance measurement unit 16 sets an even larger jitter amplitude in the jitter modulation signal output unit 11 in step S6. In the processing of step S6 in the flowchart, the jitter amplitude is gradually increased from the lower limit value LL set in advance for each jitter frequency.

In a case where the error measurement value obtained in step S8 is larger than the predetermined allowable value Th (NO in step S9), the jitter tolerance measurement unit 16 estimates the maximum jitter amplitude at which the error measurement value obtained in step S8 is equal to or less than the predetermined allowable value Th as the jitter tolerance at a currently set jitter frequency in step S10 (step S10).

Next, the pass/fail determination unit 17 determines the pass or fail of the jitter tolerance, which is estimated in step S10, with the jitter mask set in advance as a reference (step S11).

Next, the confidence level calculation unit 20 calculates the confidence level CL, based on the data rate converted in step S3, the number of errors of the output signal of the DUT 200 in a case where the jitter tolerance is obtained in step S10, and the measurement time and the target error rate ERₛ, which are input to the setting screen 40 in the input step S2 (confidence level calculation step S12).

In a case where the estimation processing of the jitter tolerance in step S10 has not been ended for all the jitter frequencies set in advance (NO in step S13), the jitter tolerance measurement unit 16 sets a new jitter frequency in the jitter modulation signal output unit 11 in step S5.

In a case where the estimation processing of the jitter tolerance in step S10 has ended for all the jitter frequencies set in advance (YES in step S13), the control unit 15 displays, on the display unit 32, the result display screen 50 showing the jitter tolerance estimated in step S10, the determination result of the pass or fail of the jitter tolerance determined in step S11, and the confidence level CL calculated in the confidence level calculation step S12. Further, in a case where the user presses the “Detail” soft key 52 on the result display screen 50, the control unit 15 displays the detailed result display screen 60 on the display unit 32 (result display screen display step S14).

As described above, the jitter tolerance measurement apparatus 1 according to the present embodiment automatically calculates the confidence level CL of the output signal of the DUT 200 in a case where the jitter tolerance is obtained, and displays the measurement result of the jitter tolerance and the confidence level CL on the result display screen 50. Accordingly, in the jitter tolerance measurement apparatus 1 according to the present embodiment, the user can quickly and easily check the confidence degree of the jitter tolerance after the jitter tolerance test.

Further, the jitter tolerance measurement apparatus 1 according to the present embodiment displays, on the result display screen 50, the determination result of the pass/fail determination unit 17 and the confidence level CL for each jitter frequency. Accordingly, in the jitter tolerance measurement apparatus 1 according to the present embodiment, the user easily verifies the pass or fail determination by the pass/fail determination unit 17 using the confidence level CL.

Further, in the jitter tolerance measurement apparatus 1 according to the present embodiment, the jitter tolerance, the determination result of the pass/fail determination unit 17, and the confidence level CL for each jitter frequency, which are displayed on the result display screen 50, are output in the predetermined file format. Accordingly, in the jitter tolerance measurement apparatus 1 according to the present embodiment, the user easily verifies the measurement result of the jitter tolerance test using the confidence level CL even at a later date after the jitter tolerance test.

### DESCRIPTION OF REFERENCE NUMERALS AND SIGNS

1: jitter tolerance measurement apparatus
10: jitter generation unit
11: jitter modulation signal output unit
12: jitter clock output unit
13: pattern signal generation unit
14: error measurement unit
15: control unit
16: jitter tolerance measurement unit
17: pass/fail determination unit
18: transfer rate conversion unit
20: confidence level calculation unit
21: result output unit
30: data storage unit
31: operation unit
32: display unit
40: setting screen
41a, 41b: pull-down menu
42a, 42b: radio button
43, 44, 45a, 45b, 46: spin box
50: result display screen
51: measurement result table
60: detailed result display screen (result display screen)
61: detailed measurement result table
200: DUT

What is claimed is:

1. A jitter tolerance measurement apparatus comprising:
a jitter modulation signal output unit that outputs a jitter modulation signal having variable jitter amplitude and jitter frequency;
a jitter clock output unit that receives the jitter modulation signal from the jitter modulation signal output unit and outputs a jitter clock subjected to phase modulation in accordance with the jitter amplitude and the jitter frequency;
a pattern signal generation unit that outputs a pattern signal in synchronization with the jitter clock to a device under test;
an error measurement unit that measures the number of errors and an error rate of an output signal of the device under test that receives the pattern signal, over a predetermined measurement time;
a jitter tolerance measurement unit that changes the jitter amplitude and the jitter frequency of the jitter modulation signal output from the jitter modulation signal output unit to estimate, as a jitter tolerance of the device under test, a maximum jitter amplitude at which the number of errors or the error rate measured by the error measurement unit is equal to or less than a predetermined allowable value for each jitter frequency;
a display unit that displays a result display screen showing the jitter tolerance and a setting screen for performing setting related to a measurement condition for the jitter tolerance,
in which the result display screen displays the jitter tolerance and a confidence level, and
the setting screen includes
a measurement time input unit to which the measurement time of the output signal is input, and
a target error rate input unit to which an allowable value of the error rate of the output signal is input; and
a confidence level calculation unit that calculates the confidence level related to the allowable value of the error rate of the output signal,
wherein the confidence level calculation unit calculates the confidence level based on a data rate of the output signal, the number of errors of the output signal in a case where the jitter tolerance is obtained by the jitter tolerance measurement unit, and the measurement time and the allowable value of the error rate that are input to the setting screen.

2. The jitter tolerance measurement apparatus according to claim 1,
wherein the confidence level calculation unit calculates the confidence level by substituting a product of the data rate and the measurement time into N of Equation (2), substituting the allowable value of the error rate into ERₛ of Equation (2), and substituting the number of errors into E of Equation (2),
$$CL = 1 - {e}^{- N \times {ER}_{S}} \times {\sum }_{k = 0}^{E} \frac{{( N \times {ER}_{S} )}^{k}}{k !} . \qquad ( 2 )$$

3. The jitter tolerance measurement apparatus according to claim 1, further comprising:
a pass/fail determination unit that determines a pass or fail of the jitter tolerance with a jitter mask set in advance as a reference,
wherein the result display screen displays the jitter tolerance, a determination result of the pass/fail determination unit, and the confidence level for each jitter frequency.

4. The jitter tolerance measurement apparatus according to claim 3, further comprising:
a result output unit that outputs the jitter tolerance, the determination result of the pass/fail determination unit, and the confidence level for each jitter frequency, which are displayed on the result display screen, in a predetermined file format.

5. A jitter tolerance measurement method using a jitter tolerance measurement apparatus including
a jitter modulation signal output unit that outputs a jitter modulation signal having variable jitter amplitude and jitter frequency,
a jitter clock output unit that receives the jitter modulation signal from the jitter modulation signal output unit and outputs a jitter clock subjected to phase modulation in accordance with the jitter amplitude and the jitter frequency,
a pattern signal generation unit that outputs a pattern signal in synchronization with the jitter clock to a device under test,
an error measurement unit that measures the number of errors and an error rate of an output signal of the device under test, which receives the pattern signal, over a predetermined measurement time,
a jitter tolerance measurement unit that changes the jitter amplitude and the jitter frequency of the jitter modulation signal output from the jitter modulation signal output unit to estimate, as a jitter tolerance of the device under test, a maximum jitter amplitude at which the number of errors or the error rate measured by the error measurement unit is equal to or less than a predetermined allowable value for each jitter frequency, and
a display unit that displays a result display screen showing the jitter tolerance and a setting screen, the jitter tolerance measurement method comprising:
a setting screen display step of displaying, on the display unit, the setting screen for being used to perform setting related to a measurement condition for the jitter tolerance;
an input step of inputting the measurement time of the output signal and an allowable value of the error rate of the output signal to the setting screen;
a confidence level calculation step of calculating a confidence level related to the allowable value of the error rate based on a data rate of the output signal, the number of errors of the output signal in a case where the jitter tolerance is obtained by the jitter tolerance measurement unit, and the measurement time and the allowable value of the error rate that are input to the setting screen; and
a result display screen display step of displaying, on the display unit, the result display screen showing the jitter tolerance and the confidence level,
wherein the setting screen includes
a measurement time input unit to which the measurement time of the output signal is input, and
a target error rate input unit to which the allowable value of the error rate of the output signal is input.

6. The jitter tolerance measurement method according to claim 5,
wherein, in the confidence level calculation step, the confidence level is calculated by substituting a product of the data rate and the measurement time into N of Equation (2), substituting the allowable value of the error rate into ERₛ of Equation (2), and substituting the number of errors into E of Equation (2),
$$CL = 1 - {e}^{- N \times {ER}_{S}} \times {\sum }_{k = 0}^{E} \frac{{( N \times {ER}_{S} )}^{k}}{k !} . \qquad ( 2 )$$

7. The jitter tolerance measurement method according to claim 5,
wherein pass/fail determination of determining a pass or fail of the jitter tolerance is performed with a jitter mask set in advance as a reference, and
the result display screen displays the jitter tolerance, a determination result of the pass/fail determination, and the confidence level for each jitter frequency.

8. The jitter tolerance measurement method according to claim 7,
wherein a result output of outputting the jitter tolerance, the determination result of the pass/fail determination, and the confidence level for each jitter frequency, which are displayed on the result display screen, in a predetermined file format is performed.
